(19) United States
(12) Patent Application Publication
(10) Pub. No.: US 2004/0102981 A1
(43) Pub. Date: May 27, 2004

(54) Web-based vendor management system

(75) Inventors: James Michael Schuh, Appleton, WI (US); Jeffrey Scott Wysocki, Appleton, WI (US); James Timothy Baer, Appleton, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/302,427

(22) Filed: Nov. 22, 2002

(51) Int. Cl. G06F 17/60

(52) U.S. Cl. 705/1

(57) ABSTRACT

A system for managing vendor data, the system including a vendor component controlled by an owner and accessible to a vendor, wherein the vendor component is adapted to allow the vendor to enter vendor-supplied data describing the vendor, and further adapted to allow the vendor to update the vendor-supplied data; and an owner component associated with the vendor, controlled by the owner, and inaccessible to the vendor, wherein the owner component is adapted to allow the owner to enter owner-supplied data describing the vendor, and further adapted to allow the owner to review the vendor-supplied and owner-supplied data.

### BACKGROUND

Corporations and other entities keep records of contacts with outside vendors to enable the corporation to find a source for goods or services when a need arises. These records may take the form of vendor brochures and other literature, telephone contact records, meeting notes, contracts, and information in many other formats. These records are typically stored by whomever made the contact.

### SUMMARY OF THE INVENTION

Because of the nature of these records and their distributed storage, corporations and other entities face many difficulties in managing contacts with outside vendors. Vendors may contact multiple parties in the corporation by phone or in meetings over a period of time, without there being a central means to store the knowledge and decisions that have been made regarding vendor proposals or services. Thus, there is a need for a centralized means of receiving, storing, and distributing information obtained from contacts with vendors to reduce duplication of efforts, to simplify decision making, and to increase the availability of information throughout the corporation.

The present invention overcomes these problems by providing a system for managing vendor data, the system including a vendor component controlled by an owner and accessible to a vendor, wherein the vendor component is adapted to allow the vendor to enter vendor-supplied data describing the vendor, and further adapted to allow the vendor to update the vendor-supplied data; and an owner component associated with the vendor, controlled by the owner, and inaccessible to the vendor, wherein the owner component is adapted to allow the owner to enter owner-supplied data describing the vendor, and further adapted to allow the owner to review the vendor-supplied and owner-supplied data.

The present invention also provides a system for managing vendor data, the system including a computer including a browser-based application adapted to collect vendor-supplied data from a vendor; a communication link accessible to the vendor to link the vendor to the computer; a first interface accessible to the vendor adapted to allow the vendor to enter vendor-supplied data; a computer including a browser-based application adapted to collect owner-supplied data from an owner, wherein the owner-supplied data is inaccessible to the vendor; and a second interface accessible to the owner and inaccessible to the vendor, adapted to allow the owner to access and enter owner-supplied data.

The present invention also provides a method for a vendor to manage vendor data available to a customer, the method including contacting the customer to obtain access to a data management system of the customer; accessing the data management system via the Internet; entering vendor data into the data management system; reviewing vendor data in the data management system; and updating vendor data in the data management system.

The present invention also provides a method for an owner to manage vendor data, the method including providing a data management system capable of receiving and storing vendor-supplied data; providing a link via the Internet to the data management system accessible to a vendor such that the vendor may enter vendor-supplied data; and providing an application accessible to the owner to review vendor-supplied data and add owner-supplied data.

The present invention provides several attributes that are advantageous. A vendor has ultimate responsibility for entering and maintaining up-to-date information, and it is in their best interests to do so. Also, a user may immediately access the user's entire company's knowledge and experience with a vendor, rather than such knowledge and experience being spread across many people's memories and many obscure file drawers.

Other objects and advantages of the present invention will become more apparent to those skilled in the art in view of the following description and the accompanying drawings.

### BRIEF DESCRIPTION OF THE DRAWINGS

FIG. 1 is a schematic representation of a vendor management system of the present invention.

FIG. 2 is an exemplary screen shot view of a vendor data entry screen of the system shown in FIG. 1.

### DETAILED DESCRIPTION OF THE PREFERRED EMBODIMENTS

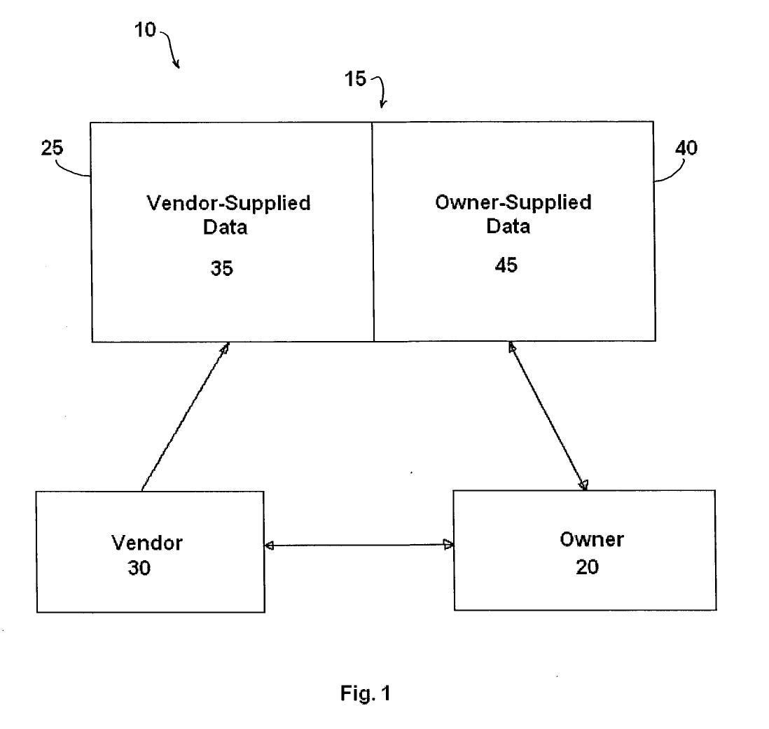

FIG. 1 illustrates an example of a web-based vendor management system 10 of the present invention. The system 10 includes an application 15 resident on a computer server run by an owner 20 or designee of the owner 20. The owner 20 may be a corporation, a subset of a corporation, and individual, or other suitable entity.

The application 15 is preferably web-based to provide nearly universal accessibility to any relevant entity.

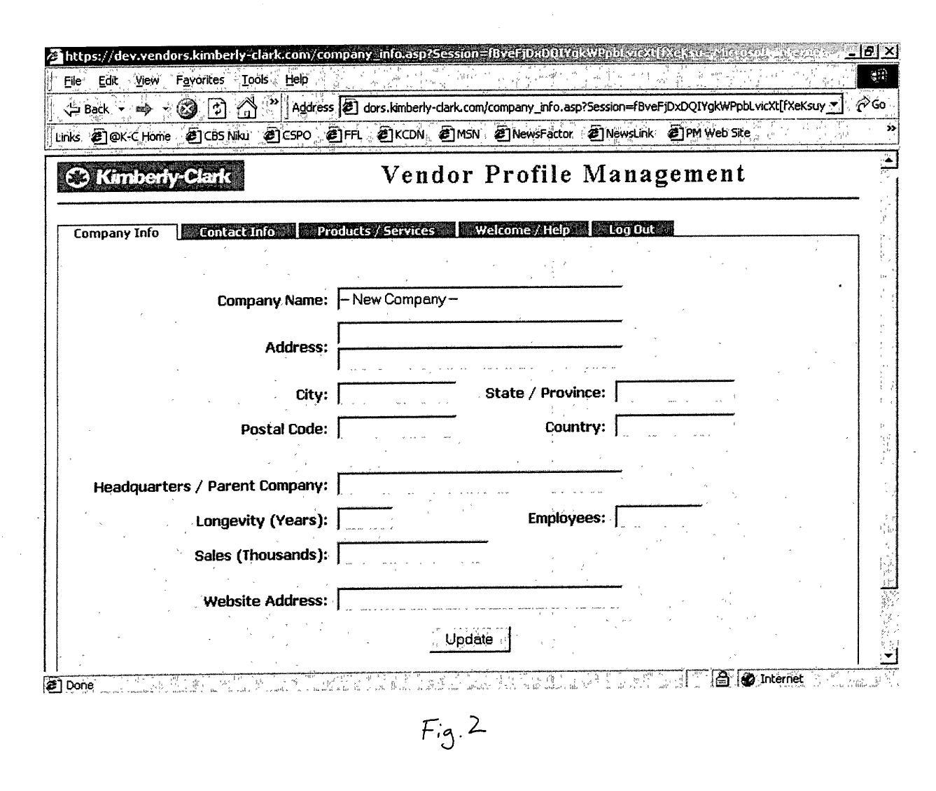

The application 15 includes a vendor component or side 25. The vendor component 25 is designed to collect and store data related to a vendor 30, and may accommodate any number of vendors 30. FIG. 2 illustrates a sample data entry page accessible to a vendor 30. The information the vendor may enter includes the vendor's name and address, any other entities associated with the vendor 30, the number of employees and sales of the vendor 30, contact information, descriptions of services or proposals, selection of categories describing the vendor and vendor products, optional information regarding competitors, and so forth. Further, the vendor may add electronic attachments such as brochures, annual reports, written proposals, URLs to selected vendor Web pages or files on other servers, and the like in an attachment region for the vendor 30. Further, the vendor may add any other relevant information that may aid a customer in evaluating the vendor 30. This information supplied by the vendor may be referred to collectively as vendor-supplied data 35.

The vendor component 25 is preferably connected to the Internet to provide access outside the owner 20 to vendors 30 and potential vendors 30. The owner 20 provides a vendor 30 with a web address so that the vendor 30 may access the system 10. A vendor 30 is provided with a URL where it may create its own account with a username and password to access a secure Web site where the vendor 30 may provide vendor-supplied data 35 unique to the vendor 30. The Web environment offered to the vendor 30 after logging in pertains only to that vendor 30. The system 10 may also include a security component that requires the vendor 30 to enter a login name and a password or other identifying information to enhance the confidentiality and security of the system 10.

The information and electronic attachments included in the vendor-supplied data 35 are then stored on an owner server to provide owner employees with access to the vendor-supplied data 35.

The application 15 also includes an owner component or side 40. In addition to information entered by the vendor 30, the Web-based system 10 also includes an owner component 40 available only to authorized users in the owner 20 where further data relative to a particular vendor 30 may be entered by employees of the owner 20. Data entered may be anything associated with the vendor 30 or anything that would help employees of the owner 20 to identify and evaluate the vendor 30. Data may include records, notes, and minutes of meetings with the vendor 30, where the term “meeting” refers to any personal contact, including a telephone conversation, a videoconference, a personal meeting, a teleconference, an Internet meeting, or combinations thereof. Data may also include ratings/status of the vendor 30 (e.g., level of interest, recommendations, preferability of the vendor 30, etc.), past embodiments of company (pre-merger, etc.), history of dealings with the vendor 30, safety information, regulatory information, qualifications (e.g., ISO 9000), quarterly reviews and updates, statuses of agreements such as confidential disclosure agreements including terms and expiration information, other comments, and so forth. Data may also include links to information including financial databases, catalogs, links to third parties on web, vendor specs, work/purchase orders, a comparison of contract terms versus audit results, and a link to a legal database. This data entered by the owner 20 or representatives of the owner 20 may be referred to collectively as owner-supplied data 45.

The owner component 40 is connected to the Internet or to an intranet within the owner 20 to provide access to the system 10 by those people associated with the owner 20. The owner employees may also access the vendor component 25 to review data entered by a vendor 30. The system 10 may be configured to restrict access by owner employees to various portions of the system 10. For example, an owner employee may only be able to access the vendors of certain good and services. In another example, permission to add or alter data in the owner component 40 may be given only to system administrators, or team leaders, or the like. In general, the system 10 may be freely accessible, or may be restricted in access by vendor type, data type, vendor status, reason for accessing data (e.g., reviewing data versus altering data), or any other suitable reason for restriction.

The system 10 may also have other features. Key word filters may be identified to help employees search for particular data or to alert employees when certain vendors enter data. Data on the system 10 may be changed or removed; vendors may access their vendor component 25 and update data, for example. Employees of the owner 20 may access the owner component 40 for a particular vendor 30 to add meeting notes, for example. Both the vendor and owner components 25, 40 may include a help function to assist users. The system 10 may also screen users to ensure that a given user has received sufficient training to be able to use the system 10 effectively. Data may be made searchable by words, category, status, etc. The system 10 may characterize vendors by any meaningful classification, including minority-ownership, financial stability, and quality programs.

Further, the system 10 may identify an owner contact for each vendor 30, and a vendor contact for each vendor 30. The system 10 may also generate and send an e-mail notification to a vendor 30 when the vendor 30 needs to update the vendor-supplied data 35 associated with that vendor 30. When vendor-supplied data 35 is entered initially or updated, e-mails may be sent to the vendor 30 to confirm the changes, and to the owner 20 to notify the owner 20 that the vendor 30 has updated the vendor-supplied data 35. The system 10 may also check for and eliminate duplicate vendor-supplied data 35 and duplicate vendors 30. The system 10 may also accommodate files in different formats including pdf, ppt, xls, doc, etc.

In use, a vendor 30 contacts an owner 20 to obtain contact information including the URL for the vendor management system 10, and instructions on how to use the system 10. Using a browser-based Internet connection, the vendor 30 links to the vendor component 25 of the system 10, but only to the specific vendor component 25 associated with that vendor 30, and not to other vendor data or any owner components 40. The vendor 30 uses or establishes the vendor's identification information to gain secure access through SSL encryption to the system 10. Once the vendor 30 has access to the vendor component 25 of the system 10, the vendor 30 may input or update the types of vendor-supplied data 35 described above. Once data entry is complete, the system 10 updates the records of the vendor 30, and generates and sends an e-mail to the vendor 30 confirming the update. The system 10 also sends e-mails to interested parties or administrators of the owner 20.

The owner 20 then has a meeting with the vendor 30 to discuss what the vendor 30 has to offer, or what the owner 20 is looking for. After the meeting, the owner 20 enters owner-supplied data 45 about the vendor 30 into the owner component 40 of the system 10. In one embodiment, each person meeting with the vendor 30 is asked to enter information pertaining to the meeting into the owner component 40 of the vendor management system 10. A paper form may be used to obtain this information, allowing a secretary or other party to later enter it electronically, or it may be entered electronically in the first place.

Later, an authorized employee of the owner 20 may search the vendor management system 10 to evaluate vendor-supplied data 35 and owner-supplied data 45. The employee may search for a particular vendor 30, or for all vendors associated with a particular good or service, or by any other criteria as described above. The employee may review vendor-supplied data 35 entered by the vendor 30 as well as owner-supplied data 45 entered by other employees concerning the vendor 30.

Potential specific uses for the vendor management system 10 include researching potential vendors 30 that may be useful in fulfilling a particular need, and ensuring capabilities will be available for planned projects. In another example, the vendor management system 10 may be used to answer Federal Bureau of Investigation requests concerning whether the owner 20 has used certain vendors 30.

Each vendor 30 has the ultimate responsibility for entering and maintaining up-to-date information in the vendor management system 10. It is also in each vendor's best interests make sure information is accurate to provide the owner 20 with the best data available.

An owner 20 may immediately access the owner's entire knowledge of and experience with a particular vendor 30, rather than having such knowledge and experience spread across many people's memories and many obscure file drawers.

An important advantage of the vendor management system 10 is the ability that it offers to owner employees to rapidly access a centralized source of information regarding the vendor 30 and past contacts with the vendor 30. Thus, when a vendor 30 calls a marketer, for example, with a marketing proposal, the marketer may access the web-based records for the vendor 30 and learn who has been working with the vendor 30 already in the past after only a few seconds into the phone call. Judgments and experiences of others with the vendor 30 may be reviewed, allowing for a more effective interaction with the vendor 30.

Another important benefit is the ability to provide updated brochures, slide materials, and other vendor-supplied data 35 in a common, readily accessible location. Instead of having to sort through a file cabinet to find a brochure that may be outdated, users of the vendor management system 10 may access an electronic file and know its date of entry in the vendor management system 10.

The vendor management system 10 may also efficiently communicate the status of confidentiality agreements and other legal matters relating to the vendor 30, with the data being entered in the owner component 40. Other databases, both inside and outside the owner 20, may be accessible via links in the owner component 40 associated with the vendor 30 or may be used to display live information directly on a web page in the administrative area for the vendor 30.

Other objects and advantages of the present invention will become more apparent to those skilled in the art in view of the following description and the accompanying drawings.

The invention has been described with reference to various specific and illustrative embodiments and techniques. However, it should be understood that many variations and modifications may be made while remaining within the spirit and scope of the invention. Many alternatives, modifications and variations will be apparent to those skilled in the art in light of the foregoing description. Accordingly, this invention is intended to embrace all such alternatives, modifications, and variations that fall within the spirit and scope of the appended claims.

We claim:

1. A system for managing vendor data, the system comprising:
a vendor component controlled by an owner and accessible to a vendor, wherein the vendor component is adapted to allow the vendor to enter vendor-supplied data describing the vendor, and further adapted to allow the vendor to update the vendor-supplied data; and
an owner component associated with the vendor, controlled by the owner, and inaccessible to the vendor, wherein the owner component is adapted to allow the owner to enter owner-supplied data describing the vendor, and further adapted to allow the owner to review the vendor-supplied and owner-supplied data.

2. The system of claim 1, wherein the vendor component is adapted to require security information for a vendor to access the vendor component.

3. The system of claim 2, wherein the security information is a user identification and a password.

4. The system of claim 1, further comprising an application portion adapted to notify the vendor when the vendor-supplied data needs to be updated.

5. The system of claim 4, wherein the vendor is notified by e-mail.

6. The system of claim 1, wherein the vendor component includes a help function.

7. The system of claim 1, wherein the owner component is adapted to screen users to ensure appropriate training.

8. The system of claim 1, wherein the vendor-supplied data is searchable.

9. The system of claim 1, wherein the owner-supplied data is searchable.

10. The system of claim 1, further comprising an application portion adapted to notify the owner when the vendor has updated the vendor-supplied data.

11. The system of claim 1, wherein the owner component is adapted to allow a user to rate the vendor.

12. The system of claim 1, wherein the vendor and owner components are web-based.

13. The system of claim 1, wherein the vendor is prevented from accessing the owner component.

14. The system of claim 1, wherein the vendor component is accessible via the Internet.

15. The system of claim 1, wherein the vendor component is accessible via telephone.

16. The system of claim 1, wherein the owner component is accessible via intranet.

17. The system of claim 1, wherein access to the owner component is restricted.

18. The system of claim 1, wherein the vendor-supplied data is selected from the group consisting of brochures, catalogs, contacts, price lists, web links, photographs, audio recordings, video recordings, product descriptions, product availability, comments, letters, and bills.

19. The system of claim 1, Wherein the owner-supplied data is selected from the group consisting of brochures, contacts, price lists, web links, photographs, audio recordings, video recordings, product descriptions, product availability, comments, telephone records, meeting minutes, meeting notes, contracts, letters, agreements, purchase orders, and bills.

20. A system for managing vendor data, the system comprising:
a computer including a browser-based application adapted to collect vendor-supplied data from a vendor;
a communication link accessible to the vendor to link the vendor to the computer;
a first interface accessible to the vendor adapted to allow the vendor to enter vendor-supplied data;
a computer including a browser-based application adapted to collect owner-supplied data from an owner, wherein the owner-supplied data is inaccessible to the vendor; and
a second interface accessible to the owner and inaccessible to the vendor, adapted to allow the owner to access and enter owner-supplied data.

21. The system of claim 20, wherein the owner-supplied data and the vendor-supplied data are of different types.

22. A method for a vendor to manage vendor data available to a customer, the method comprising:
contacting the customer to obtain access to a data management system of the customer;
accessing the data management system via the Internet;
entering vendor data into the data management system;
reviewing vendor data in the data management system; and
updating vendor data in the data management system.

23. The method of claim 22, further comprising responding to an e-mail sent by the customer requiring the vendor to update the vendor data.

24. The method of claim 22, further comprising tracking vendor records that have not been updated.

25. A method for an owner to manage vendor data, the method comprising:
providing a data management system capable of receiving and storing vendor-supplied data and owner-supplied data;
providing a link via the Internet to the data management system accessible to a vendor such that the vendor may enter vendor-supplied data; and
providing an application accessible only to the owner to review vendor-supplied data and to add owner-supplied data.

26. The method of claim 25, further comprising assigning an owner contact for the vendor.

27. The method of claim 25, further comprising checking for duplicate vendors.

28. The method of claim 25, further comprising rating the vendor.

29. An information system comprising:
a communications link adapted to allow a vendor to transmit vendor-supplied data;
a database adapted to receive the vendor-supplied data entered directly by a vendor and owner-supplied data entered directly by an owner, wherein the owner-supplied data is associated with the vendor; and
a retriever system adapted to allow the owner to retrieve the vendor-supplied data and the associated owner-supplied data.
